(19) United States
(12) Patent Application Publication
(10) Pub. No.: US 2009/0223064 A1
(43) Pub. Date: Sep. 10, 2009

(54) TOOL WITH EXCHANGEABLE PIECE

(76) Inventor: David J. Venderley, Fort Wayne, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/044,592

(22) Filed: Mar. 7, 2008

(51) Int. Cl. B23D 79/08; A47L 13/08; B23D 79/10; B25G 1/00; B44D 3/16; B25G 3/00; B26B 3/00; B26B 1/10

(52) U.S. Cl. 30/169; 15/145; 15/236.01; 16/422; 81/489; 30/342; 30/329

(57) ABSTRACT

A hand tool made up of a handle member and a tool clamp member where the handle member is made to receive the tool clamp member by engaging a flat surfaced extension of the tool clamp member with a mating hole in the handle member. The flat surfaced extension is tapered in shape and matches with a tapered hole in the handle providing a rigid fit when the handle member and tool clamp member are pressed together. The rigid fit of the two pieces is achieved by elastic properties of the handle member against the externally tapered flat surfaced extension of the tool clamp. The tool clamp provides means to uses replaceable blades or other tools to maintain the tool in good working condition while in use.

### BACKGROUND OF THE INVENTION

This invention pertains to the field of tools, such as tools designed to carry sharp blades for scraping or stripping surfaces.

Hand-held or manual scraping tools have long been used to remove materials such as paint, wall coverings and flooring material from walls, floors and other planar surfaces. Commercially available hand-held scraper devices generally have a handle portion and an attached clamp portion in which is clamped or otherwise held a metal blade. The majority of the current scraping tools are fashioned to be strictly manually operated, thus limiting their utility.

Other known tool systems that provide for use in a handle or in power tool rely on multi-component systems to attach the tool or tool holder to a handle and may need additional tools such as a screw driver to remove the tool from the handle portion. Multiple pieces of the tool or handle add to the complexity and cost to the manufacturing of the tool. Also tools adapted for use in a power tool, such as a power reciprocating saw tend to be a single piece, so when the cutting edge becomes dull or damaged, the tool must either be replaced or the cutting edge needs to be skillfully sharpened. A damaged edge or a poorly sharpened edge may result in gouging the surface being scraped, therefore it is important to maintain a sharp edge in good condition.

### SUMMARY OF THE INVENTION

One aspect of this invention is a handle member that may be fashioned as a single piece that needs no other tools to attach the tool or tool clamp to the handle member providing an easy quick method for switching between uses. Since the handle member is a single piece, it is easy and cost effective to manufacture, and this also dispenses with the problems of multiple pieces to produce and then having to assemble to make the final product. This embodiment can use a plastic handle member with a tapered hole in one end where the tapered hole only retains tools using the elastic properties of the plastic handle against the externally tapered engaging portion of the tool to be held.

Another embodiment of the invention is a tool clamp that provides the ability to be used either as a hand tool by using with a handle member or with a power tool, such as a power reciprocating saw. An advantage of this embodiment is that no other tool is needed to remove the tool clamp from the handle member and the tool clamp member is immediately ready for use in a power tool. The tool clamp also provides for easy exchange of tools or blades that can be fitted into its clamp, for example, the use of replaceable blades, so that sharpening is not necessary when the cutting edge becomes dull or damaged. The tool clamp has an extension that is adapted for use with a handle member and a power reciprocating saw. The extension may be tapered to match a taper in the receiving hole of the handle member to make a rigid fit.

In other embodiments an extension can be added to the handle and the tool clamp member can simply be inserted into a matching shaped hole of the handle without the use of tools to provide a rigid fit.

### BRIEF DESCRIPTION OF THE DRAWINGS

FIG. 1 is an exploded view of the preferred embodiment of the invention utilizing a straight blade in the tool clamp.

FIG. 2 is a cutaway view of the handle member of FIG. 1 showing the tapered slot and internal threads.

FIG. 3 is a top view of the assembled tool clamp of FIG. 1 with a straight blade attached.

FIG. 4 is a side view of the assembled tool clamp of FIG. 1 with a straight blade attached.

FIG. 5 is a detailed view of the clamping section of the tool clamp of FIG. 4.

FIG. 6 is a perspective view of the preferred embodiment of the assembled system of FIG. 1 showing the attachment of an optional commercially available extension handle.

### DETAILED DESCRIPTION OF THE INVENTION

The foregoing “Summary of the Invention,” as well as the following detailed description of preferred embodiments will be better understood when read in conjunction with the appended drawings. For the purpose of illustrating the invention, there is shown in the drawings an embodiment which is presently preferred, it being understood, however, that the invention is not limited to the specific arrangements and instrumentalities disclosed.

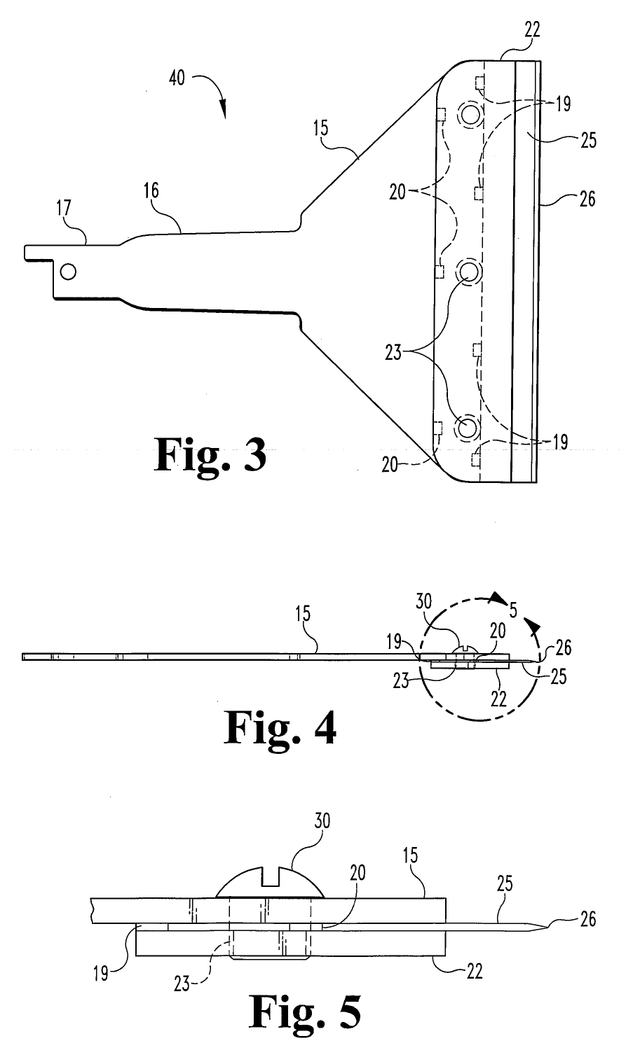

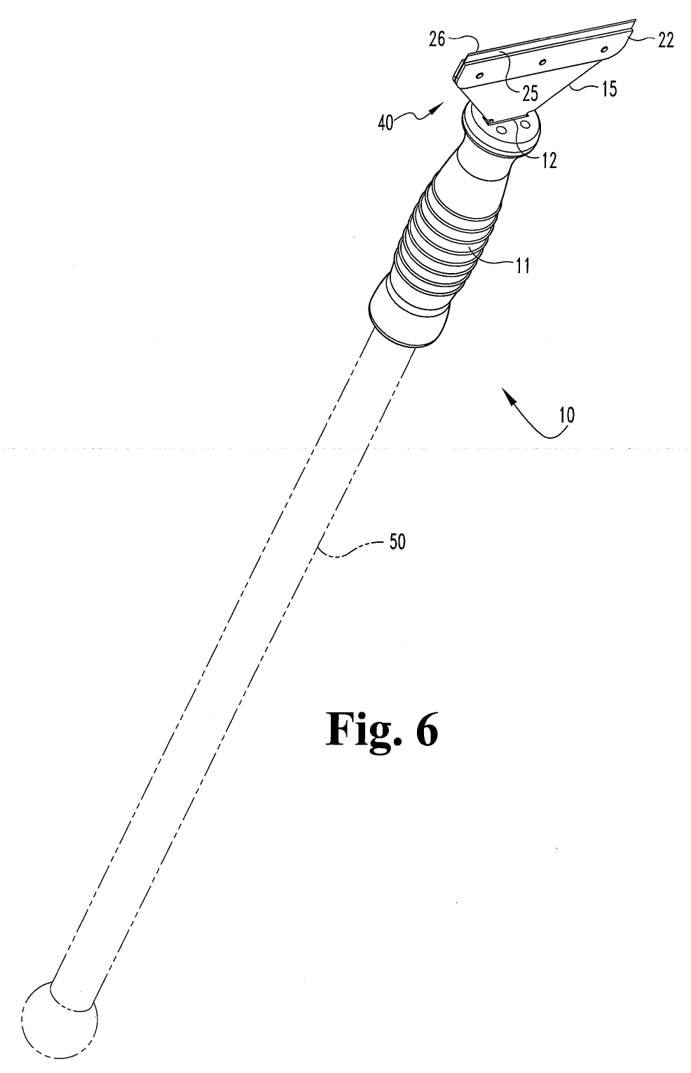

In the preferred embodiment as shown in FIG. 6, the tool clamp 40 is engaged with the handle member 11 through the slot 12 by inserting the flat extension 15 (shown in FIGS. 3 and 4) of tool clamp 40 into slot 12. A slot is shown in this preferred embodiment, but other shaped holes in the handle member to receive a matching shaped extension of the tool clamp could alternately be used. The straight blade 25, having the blade edge 26 perpendicular to the longitudinal axis of handle 11 is held firmly between the clamp members 22 and 15. An optional extension handle 50 is shown engaged to the handle member 11 at the end opposite to where the tool clamp 40 is engaged. Such extension handles may be telescoping to allow for variable length. Tool clamp 40 is preferable made of a strong durable material, more preferably of metal, and most preferably of steel. Tool handle member 11 is preferably made of a plastic material, but other materials could be used.

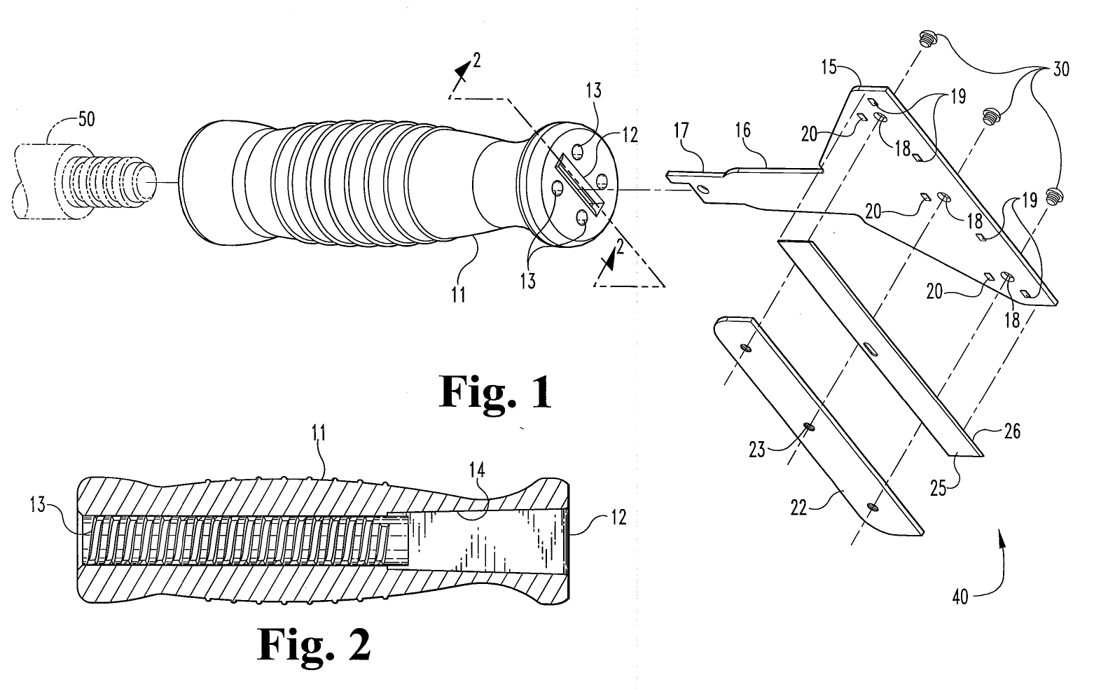

In this embodiment, the tool handle 11 is shown with 4 cavities 13 that have a depth about the same as slot 12. These cavities allow less material to be used in making the handle as well as providing for faster cooling during the molding process. Using less material allows handle 11 to be lighter weight and produced cheaper than without such holes. Even though 4 round cavities are shown in the preferred embodiment, other arrangement of cavities could be utilized to produce a similar effect. The cavities are preferably arranged such that at least one section of handle material extends from near the center of the wide dimension of either side of slot 12 to the outside of handle 11 to provide strength to support the tool while being used. Another arrangement of cavities between the slot and the outside of the handle could incorporate honeycomb shaped cavities. The cavities 13 are shown open to the outside of handle 11 as in FIG. 1, but these cavities could alternatively be completely enclosed and invisible, yet still reduce weight and cost, while maintaining adequate strength.

FIG. 3 shows the tool clamp of the preferred embodiment in more detail. The straight blade 25 is placed between clamp members 15 and 22 and rests against raised stops 19. The clamp members 15 and 22 are held together with the blade 25 in between by screws 30 extending through holes 18 of clamp member 15 to engage threaded holes 23 of the clamp member 23. The screws 30 are tightened until the clamp member 22 firmly rests on straight blade 25 and raised stops 19. Raised stops 19 are slightly less raised than raised stops 20. The tool clamp 40 is displayed with the flat extension adapted with taper 16 and the further adapted to be engaged with a reciprocating saw through end 17. Further shown in FIGS. 4 and 5, clamp member 22 is resting on blade 25 and raised stops 20 firmly clamped down by screws 30 extending through clamp member 15 and engaging the threaded holes 23 of clamp member 22.

The clamping method described here, while it is preferred, is but one of any number of ways that a tool, in this case, a straight blade, can be clamped into the tool clamp. Those practitioners in the art will recognize other methods of clamping a tool could be utilized without departing from the invention.

The tool clamp 40 is releasably engaged with the handle member 11 as displayed in FIGS. 1 and 2 by inserting the tapered flat extension 16 of tool clamp 40 in slot 12 of the handle member until the tapered extension 16 rests firmly against matching taper 14 of slot 12 of the handle. The taper 14 in FIG. 2 of handle 11 is preferably made of an elastic material, such as plastic, that is able to flexibly distort with the contact with the tapered flat extension 16 producing a force that holds the tool clamp 40 in place in handle member 11. FIG. 1 also displays the preferred orientation of the straight blade 20 with tool clamp members 15 and 22. FIGS. 1 and 2 also show the use of the optional commercial extension handle 50 engaging the internal threads 13 of the handle member 11. Using internal threads is utilized in the preferred embodiment to engage the option handle extension 50, but other methods to engage the handle extension 50 with the handle member 11 could be used as well.

What is claimed is:

1. A tool comprising
a. a blade having a long straight blade edge;
b. a clamping member removably fixing said blade by contacts at least on each side of a perpendicular plane through the center of said straight blade edge having a flat-surfaced mating end; and,
c. a mounting member releasably coupled to said clamping member by engaging said flat-surfaced mating end of said clamping member.

2. A tool of claim 1 wherein said clamping member fixes said blade where the long straight blade edge is perpendicular to a longitudinal axis of said mounting member.

3. A tool of claim 1 wherein said flat-surfaced mating end of said clamping member is tapered.

4. A tool of claim 3 wherein the engaging means of said mounting member is tapered to match said taper of said flat-surfaced mating end of said clamping member.

5. A tool comprising
a. a blade having a long straight blade edge;
b. a clamping member removably fixing said blade by contacts at least on each side of a perpendicular plane through the center of said straight blade edge, having a flat-surfaced mating end said flat-surfaced mating end adapted to be secured into a power reciprocating saw.

6. The tool of claim 5 wherein said flat-surfaced mating end adapted to be secured into a power reciprocating saw is part of a tapered extension.

7. The tool of claim 5 wherein said clamping member fixes said blade where the long straight blade edge is oriented substantially perpendicular to the central axis of said flat-surfaced mating end.

8. A tool comprising
a. a handle member having an internally tapered hole that can releasably mate with a tapered-surfaced extension and having a plastic portion that applies force to fully mated insert;
b. a tool clamp member having an externally tapered-surface extension that is inserted into said handle member engaging the internal taper of said handle member.

9. The tool of claim 8 wherein the tool clamp member is adapted to receive a straight-edged blade.

10. The tool of claim 8 wherein said internally tapered hole is a slot.

11. The tool of claim 9 wherein said internally tapered hole is a slot.

12. A handle for a tool having an externally tapered engaging portion, the handle comprising
a. a plastic handle with a tapered hole in one end in which said tapered hole primarily retains tools using the elastic properties of the plastic handle against the externally tapered engaging portion.

13. The handle of claim 12 wherein said internally tapered hole is a slot.

14. The handle of claim 13 wherein the wide dimension of the slot is tapered.

15. The handle of claim 12 wherein said handle includes an engagement mechanism for a standard threaded handle extension at the end opposite to the tapered hole.

16. A tool comprising
a. a blade having a long straight blade edge;
b. a clamping member removably fixing said blade by contacts at least on each side of a perpendicular plane through the center of said straight blade edge, having a flat-surfaced mating end said flat-surfaced mating end is tapered and adapted to be secured into a power reciprocating saw;
c. a mounting member releasably coupled to said clamping member by engaging said flat-surfaced mating end of said clamping member with a tapered slot substantially matching said taper of the said flat-surfaced mating end;
d. said mounting member also containing internal threads at an end opposite to where said mounting member is releasably coupled to said clamping member, said internal thread are suitable for adding a standard handle extension;
e. and said clamping member removably fixes said blade where the long straight blade edge is substantially perpendicular to a longitudinal axis of said mounting member.
